(19) United States
(12) Patent Application Publication
(10) Pub. No.: US 2025/0335467 A1
(43) Pub. Date: Oct. 30, 2025

(54) SYSTEM AND METHOD FOR MAINTAINING DATABASE INTEGRITY

(71) Applicant: Dell Products L.P., Round Rock, TX (US)

(72) Inventor: Richard Hicks, Pittsboro, NC (US)

(21) Appl. No.: 18/644,298

(22) Filed: Apr. 24, 2024

(51) Int. Cl. G06F 16/27; G06F 11/20

(52) U.S. Cl. CPC G06F 16/275; G06F 11/2094

(57) ABSTRACT

A system and method for maintaining database integrity. A first storage appliance receives data writes and increments an associated last sequence number (LSN) X upon each data write thereto. A second storage appliance receives data writes and increments an associated LSN Y upon each data write thereto and an external device is coupled to the first storage appliance and the second storage appliance. The first storage appliance and the second storage appliance comprise a cluster management database with data writes being replicated on both the first storage appliance and the second storage appliance. Upon the first storage appliance beginning to shut down, the LSN X is written to the external device.

### BACKGROUND

A cluster management database system includes multiple storage appliances in which one of the appliances runs as a primary instance and the remaining appliances run as secondary or standby instances. The primary instance receives write requests from a user and the writes are replicated on each of the secondary instances. In an instance in which the primary instance is shut down, for an update, for example, or other reason, the system must promote one of the secondary instances to become the primary instance. However, in order to prevent a stale database from becoming the primary instance and to determine which of the remaining databases to promote, a quorum of the databases of the system must be up and running so that the most up-to-date database can be determined and promoted. When bringing up only a subset of appliances after a cluster restart, the cluster management database (DB) will remain unavailable, until a minimum number of appliances are back up and the cluster becomes quorate. Even with the presence of an external witness service to provide an extra vote towards cluster quorum, the database may not be promotable (without the possibility of data loss), which is a requirement for restoring cluster manageability.

### SUMMARY OF DISCLOSURE

In one example implementation, a system for maintaining database integrity includes a first storage appliance for receiving data writes and incrementing an associated last sequence number (LSN) X upon each data write thereto; a second storage appliance for receiving data writes and incrementing an associated LSN Y upon each data write thereto; and an external device coupled to the first storage appliance and the second storage appliance. The first storage appliance and the second storage appliance comprise a cluster management database with data writes being replicated on both the first storage appliance and the second storage appliance. Upon the first storage appliance beginning to shut down, the LSN X is written to the external device.

One or more of the following example features may be included. One of the first storage appliance and the second storage appliance may act as a primary instance of the cluster management database and the other of the first storage appliance and the second storage appliance acts as a secondary instance of the cluster management database. The first storage appliance may be the primary instance and, when the first storage appliance shuts down, the second storage appliance may be promoted to become the primary instance and the LSN X stored in the external device may be cleared and the second storage appliance may continue to receive data writes and increment LSN Y. Upon the second storage appliance beginning to shut down, the LSN Y may be written to the external device. When the first storage appliance is restarted, it may compare its LSN X to the LSN Y stored in the external device. When LSN X equals LSN Y, the first storage appliance may be promoted to become the primary instance. When the LSN X is less than the LSN Y, the first storage appliance may not be promoted to become the primary instance. When the first storage appliance is restarted, it may compare its LSN X to the LSN Y of the second storage appliance. When the LSN X is less than the LSN Y, the second storage appliance may remain the primary instance. Writes to the second storage appliance before the first storage appliance is restarted may be written to the first storage appliance.

In another example implementation, a computer-implemented method, executed on a computing device, includes receiving data writes at a first storage appliance and incrementing an associated last sequence number (LSN) X upon each data write thereto; and receiving data writes at a second storage appliance and incrementing an associated LSN Y upon each data write thereto. The first storage appliance and the second storage appliance comprise a cluster management database with data writes being replicated on both the first storage appliance and the second storage appliance; and upon the first storage appliance beginning to shut down, writing the LSN X to an external witness device.

One or more of the following example features may be included. One of the first storage appliance and the second storage appliance may act as a primary instance of the cluster management database and the other of the first storage appliance and the second storage appliance acts as a secondary instance of the cluster management database. The first storage appliance may be the primary instance and, when the first storage appliance shuts down, the second storage appliance may be promoted to become the primary instance and the LSN X stored in the external device may be cleared and the second storage appliance may continue to receive data writes and increment LSN Y. Upon the second storage appliance beginning to shut down, the LSN Y may be written to the external device. When the first storage appliance is restarted, it may compare its LSN X to the LSN Y stored in the external device. When LSN X equals LSN Y, the first storage appliance may be promoted to become the primary instance. When the LSN X is less than the LSN Y, the first storage appliance may not be promoted to become the primary instance. When the first storage appliance is restarted, it may compare its LSN X to the LSN Y of the second storage appliance. When the LSN X is less than the LSN Y, the second storage appliance may remain the primary instance. Writes to the second storage appliance before the first storage appliance is restarted may be written to the first storage appliance.

In another example implementation, a computing system comprises a memory; and a processor configured to receive data writes at a first storage appliance and increment an associated last sequence number (LSN) X upon each data write thereto; receive data writes at a second storage appliance and increment an associated LSN Y upon each data write thereto; and write the LSN X to an external witness device upon the first storage appliance beginning to shut down; wherein the first storage appliance and the second storage appliance comprise a cluster management database with data writes being replicated on both the first storage appliance and the second storage appliance.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a database integrity maintenance process coupled to a distributed computing network according to one or more example implementations of the disclosure;

FIG. 2 is an example depiction of a system and process for maintaining database integrity in a data storage system;

FIG. 3 is an example depiction of a system and process for maintaining database integrity in a data storage system;

FIG. 4 is an example flowchart of the database integrity maintenance process according to one or more example implementations of the disclosure

FIG. 5 is an example flowchart of the database integrity maintenance process according to one or more example implementations of the disclosure; and

FIG. 6 is an example flowchart of the database integrity maintenance process according to one or more example implementations of the disclosure.

Like reference symbols in the various drawings indicate like elements.

### DETAILED DESCRIPTION

### System Overview:

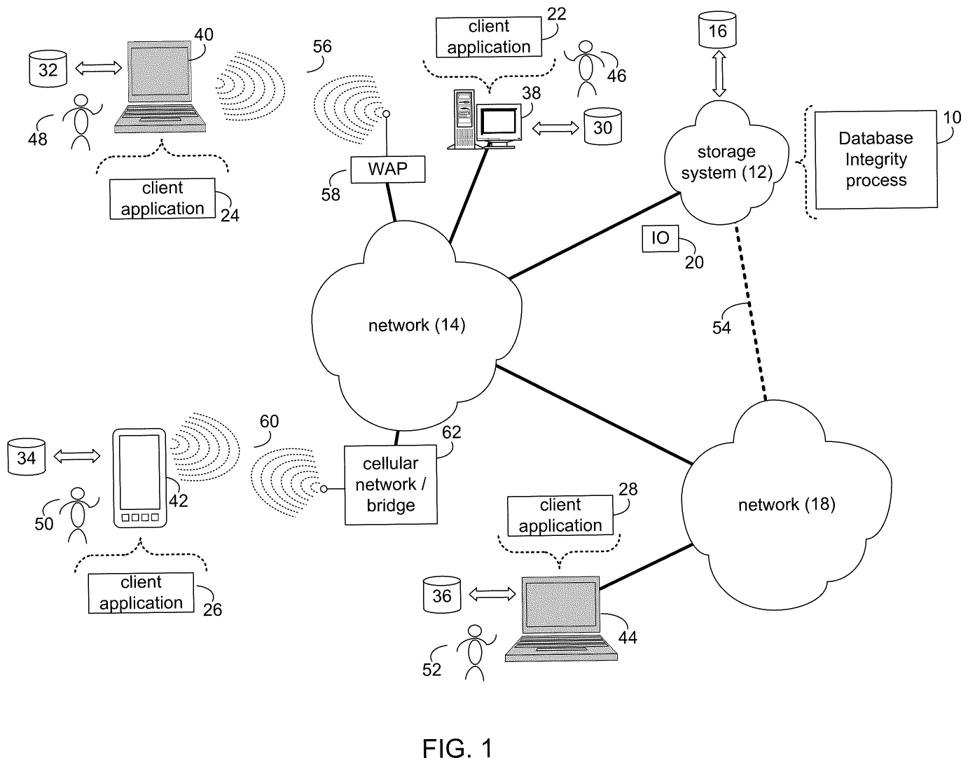

Referring to FIG. 1, there is shown database integrity maintenance process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of disability access assistance process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of disability access assistance process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a data deduplication process, such as virtual entry lifetime expansion process 10 of FIG. 1, may include but is not limited to, monitoring a deduplication function of a virtual layer of a data storage system, incrementing a reference count of a virtual entry when a data page is written to the virtual layer, decrementing the reference count of the virtual entry when a data page is deleted from the virtual layer, maintaining the virtual entry in the virtual layer when the reference count reaches a predetermined value, and reclaiming the virtual entry when a predetermined action of the data storage system is to be performed.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Database Integrity Maintenance System and Process

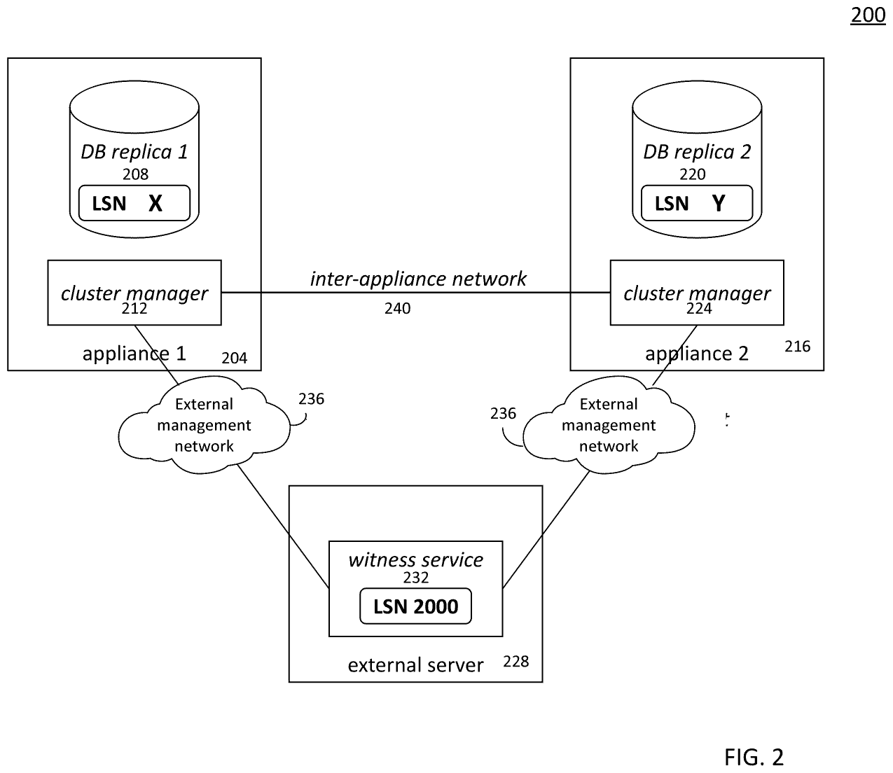

FIG. 2 is an example graphical representation 200 of a system for maintaining database integrity of a data storage system. System 200 includes a first storage appliance 204, including a first database replica 206 and a cluster manager 212, a second storage appliance 216, including a second database replica 220 and a cluster manager 224. System 200 further includes an external server 228 operating an external witness service 232. Storage appliance 204 is coupled to storage appliance 216 by inter-appliance network 240 and witness service 232 is coupled to both storage appliance 204 and storage appliance 216 over external management network 236.

A cluster manager is a software component or system responsible for the management and coordination of a cluster, which is a group of interconnected computers or servers that work together to perform computing tasks as a single system. The cluster manager oversees the operation of the cluster, including tasks such as resource allocation, load balancing, fault detection and recovery, and coordination of distributed computing tasks.

One of the primary functions of a cluster manager is resource management, which involves allocating and managing computing resources such as CPU, memory, storage, and network bandwidth across the cluster nodes. The cluster manager ensures that resources are utilized efficiently and fairly, taking into account factors such as workload demands, availability of resources, and performance requirements.

Load balancing is another important task performed by the cluster manager. It involves distributing incoming requests or tasks evenly across the cluster nodes to optimize resource utilization and improve system performance. The cluster manager continuously monitors the workload and performance of individual nodes and dynamically adjusts the distribution of tasks to maintain balanced resource utilization and prevent overloading of any single node.

Fault detection and recovery are critical aspects of cluster management, as clusters are inherently prone to failures and disruptions. The cluster manager detects and responds to failures or anomalies in the cluster nodes or components, initiating failover or recovery procedures to ensure uninterrupted operation and data integrity. This may involve restarting failed processes, migrating tasks to healthy nodes, or reconfiguring the cluster topology to work around failed components.

In addition to resource management, load balancing, and fault tolerance, a cluster manager may also provide features such as job scheduling, security management, and monitoring and reporting capabilities. These features help streamline the operation of the cluster, improve system reliability and performance, and simplify the management of complex distributed computing environments.

In database management, an external witness serves as a critical component in ensuring the reliability and integrity of high-availability configurations, particularly in scenarios such as database failover in distributed systems or clusters. The external witness acts as an independent arbiter or voter that helps determine the state of the database nodes, particularly during failover events.

Typically, in setups like database mirroring or clustering, where there are multiple nodes (such as primary and secondary nodes), the external witness plays a crucial role in deciding whether a failover should occur. It does so by participating in a quorum or voting process alongside the database nodes. When a node becomes unavailable or experiences a failure, the remaining nodes, including the external witness, collectively decide whether the remaining nodes have enough votes to continue operation or if a failover is necessary to maintain system availability and integrity.

The external witness, being external to the database nodes themselves, ensures an impartial judgment in the event of network partitions or communication failures between the nodes. Its presence helps prevent split-brain scenarios, where separate segments of the cluster mistakenly believe they are the primary active segment. By providing an external perspective, the witness helps maintain the consistency and correctness of the database cluster, enabling it to continue operating smoothly even in the face of failures or network issues.

In an implementation of the disclosure, external witness 232 also acts to cache information related to the write statuses of each of the appliances of the cluster database. As described below, this enables the promotion of a secondary instance to the primary instance in situations where the original primary instance is down and the secondary instance has not missed any writes to the database. The information cached by the external witness 232 includes a last sequence number (LSN) which is related to a count of writes to each of the primary and secondary instances.

In an implementation of the disclosure, replication between storage appliance 204 and storage appliance 216 is performed according to PostgreSQL. PostgreSQL streaming replication is a robust and widely-used feature in PostgreSQL that enables the creation of high-availability database configurations. In this setup, one PostgreSQL instance acts as the primary or master node, while one or more standby nodes replicate data from the primary in real-time, creating a synchronized copy of the database. This replication is achieved through continuous streaming of the write-ahead log (WAL) from the primary to the standby nodes, allowing them to keep up with changes made to the primary database.

The process begins with the primary node continuously writing changes to the WAL, which contains a sequential record of all modifications made to the database. The standby nodes, configured as replicas of the primary, read the WAL segments as they are produced and apply these changes to their local databases, ensuring that they stay synchronized with the primary.

Streaming replication offers several benefits, including high availability, fault tolerance, and load balancing. In the event of a primary node failure, one of the standby nodes can be promoted to serve as the new primary, minimizing downtime and ensuring continuous access to the database. Additionally, standby nodes can be used for read-only queries, offloading read traffic from the primary node and improving overall system performance.

In an implementation, appliance 204 is set to run as the primary instance and appliance 216 is set to run as a secondary or standby instance. In such a configuration, write requests are directed to the primary instance, appliance 204 and those writes are replicated on secondary instance, appliance 216 via inter-appliance network 240. With each write to replica 208 of appliance 204, a last sequence number (LSN) X is incremented and with each write to replica 220 of appliance 216, a last sequence number (LSN) Y is incremented. The LSN is essentially a counter for keeping track of writes to each replica 208, 220, in order to determine if each appliance includes a true replica of the other. In other words, if the LSN X of appliance 208 is the same as LSN Y of appliance 216, the replicas are determined to be identical. However, if LSN X and LSN Y are different at any point in time during write operations, the replica with the lowest value LSN is determined to be stale, since it has encountered less writes than the replica with the higher value LSN. Such a scenario can take place when one of the appliances is shut down or taken offline while the other appliance continues to accept writes thereto.

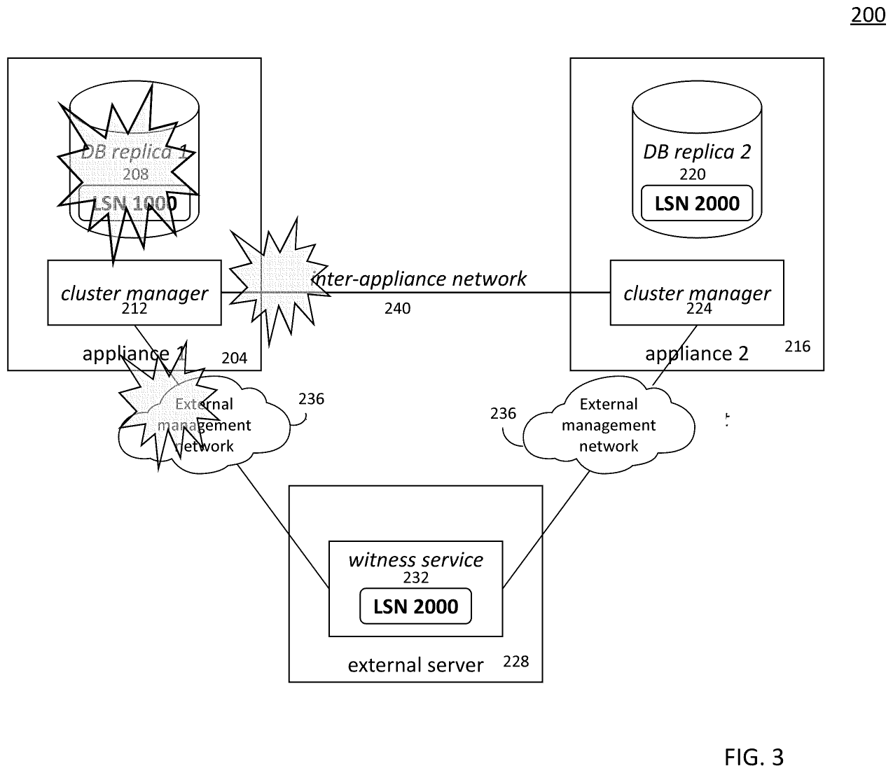

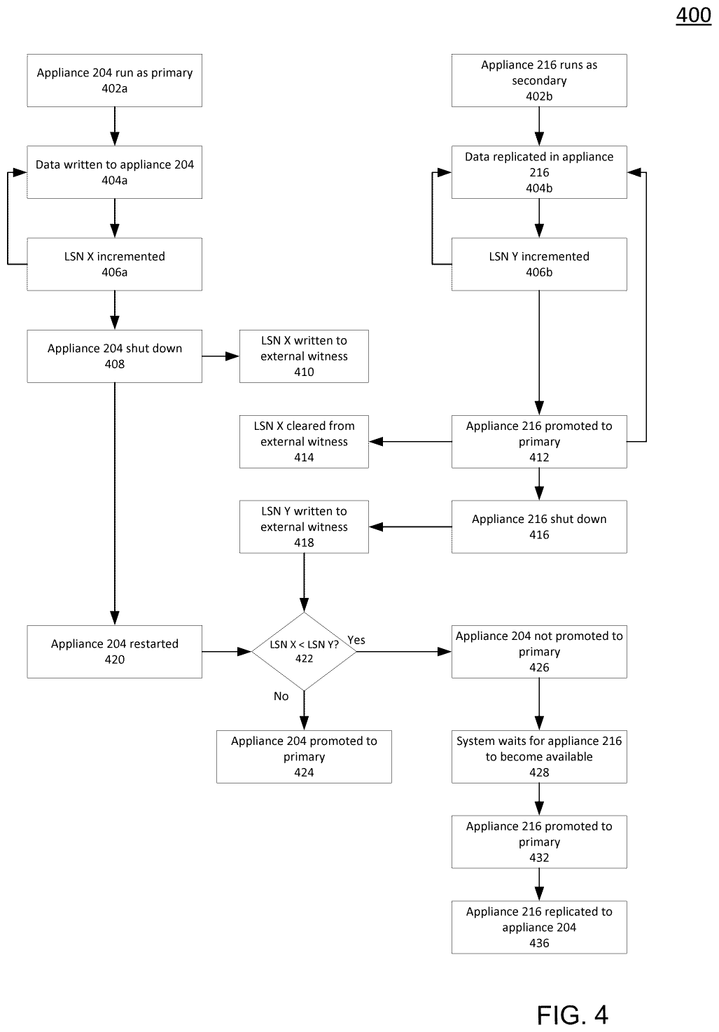

FIG. 3 is an example graphical representation 200 of a system for maintaining database integrity of a data storage system. In this figure, a situation in which appliance 204 is shut down is shown. In such a situation, appliance 204, once the shutdown is complete, is no longer coupled to appliance 216 over inter-appliance network 240 and is no longer coupled to witness service 232 over external management network 236. FIG. 4 is an example flow diagram 400 depicting operation of the system 200 to maintain database integrity when appliance 204 is shut down. During regular operation, appliance 204 is designated s the primary instance, 402a, and appliance 216 is designated as the secondary instance, 402b. Data is written to appliance 204, 404a, and replicated to appliance 216, 404b. Each time data is written to appliance 204, its LSN “X” is incremented, 406a, and each time that data is replicated to appliance 216, its LSN “Y” is incremented, 406b. This process of data writes and replications continues, along with the corresponding incrementation of the LSN associated with each appliance.

At 408, appliance 204 begins a shutdown process. Preferably, this process is carried out as a “soft” shutdown. A soft shutdown, also known as a graceful shutdown, is a controlled and orderly process of shutting down a computer system or application in a manner that allows it to complete ongoing tasks, save necessary data, and release resources properly before shutting down completely. Unlike a hard shutdown, which involves abruptly cutting off power to the system without any regard for ongoing processes or data integrity, a soft shutdown ensures that the system or application is stopped in a controlled manner, minimizing the risk of data loss, corruption, or system instability.

During a soft shutdown, the operating system or application initiates a sequence of actions to gracefully terminate running processes, close open files and connections, flush caches and buffers, and release any allocated resources such as memory or network connections. This allows the system or application to complete any pending operations, ensure data consistency, and prepare for a clean shutdown without leaving behind any lingering effects or incomplete transactions.

Soft shutdowns are particularly important in multi-user or multi-tasking environments where multiple processes or applications may be running concurrently and interacting with each other. By shutting down in a controlled manner, soft shutdowns help prevent data loss or corruption, maintain system stability, and ensure a smooth transition to the shutdown state.

In addition to user-initiated shutdowns, soft shutdown procedures may also be triggered automatically by the operating system or application in response to certain events or conditions, such as low battery levels, system errors, or scheduled maintenance tasks. This allows the system to gracefully handle unexpected shutdown scenarios and minimize disruption to users or critical operations.

During the soft shutdown process, the LSN X stored in appliance 204 is written to external witness 232, 410. In this manner, external witness is able to keep track of the last write executed on appliance 204 before it was shut down. After appliance 204 is shut down, 408, and its LSN X has been written to external witness 232, 410, appliance 216 is promoted to primary instance, since it is still up and running, 412. Upon being promoted, appliance 216 instructs external witness 232 to clear LSN X from its cache, 414. Since appliance 216 is still able to execute writes, the LSN X from appliance 204 will no longer be up-to-date with the writes executed on appliance 216. In one instance, appliance 216, as the primary instance, continues to execute writes and increment its LSN Y, 404b, 406b. However, if no writes are executed by appliance 216 while appliance 204 is down, the LSN Y of appliance 216 will not be incremented.

At 416, appliance 412 begins a shutdown process. Before shutting down, appliance 216 writes its LSN Y to external witness 232, 418. At this point, both appliance 204 and appliance 216 are shut down. When appliance 204 is restarted, 420, it checks its LSN X against the LSN cached in external witness 232, which is then LSN Y, 422. If, in between the time that appliance 204 was shut down and appliance 216 was shut down, writes were executed to appliance 216, LSN Y will be greater than LSN X and appliance 204 will be determined to be a stale replica, and it will not be promoted to primary instance 426. The system 200 will then wait for appliance 216 to become available, 428, at which time it will be promoted to primary instance, 432, since it has the most recent writes between the two appliances. Data stored on appliance 216 is then replicated to appliance 204, which is now run as the secondary instance. If no writes were executed to appliance 216 in the time between when it was promoted to primary and it was shut down, LSN X from appliance 204 will be equal to LSN Y from appliance 216, 422, and appliance 204 will be promoted to primary, 424, since it is not stale.

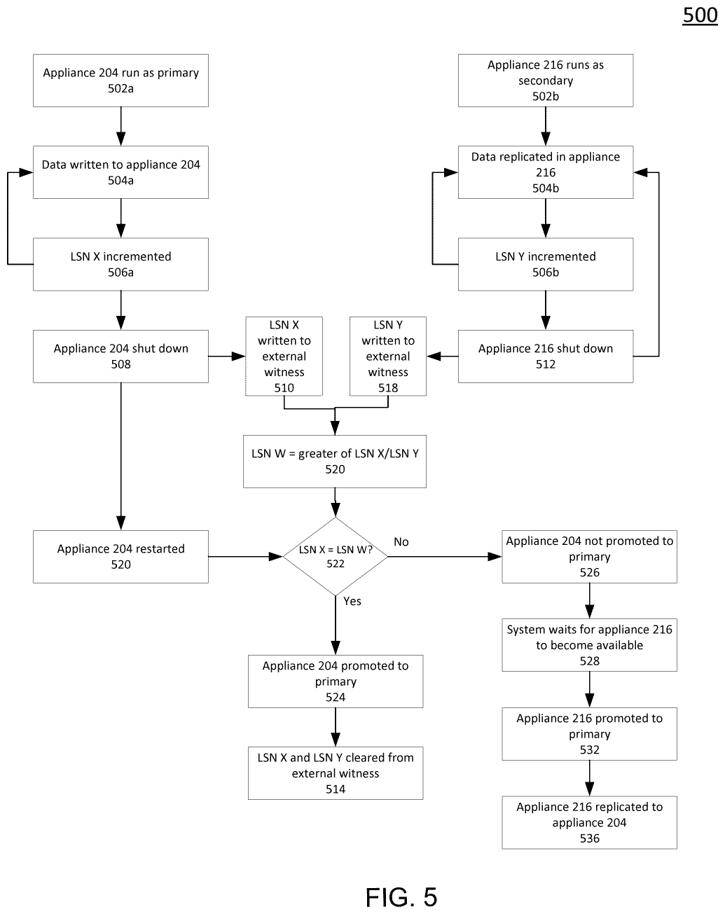

FIG. 5 is another example flow diagram 500 of an implementation of the disclosure. In this example, during regular operation, appliance 204 is designated as the primary instance, 502a, and appliance 216 is designated as the secondary instance, 502b. Data is written to appliance 204, 504a, and replicated to appliance 216, 504b. Each time data is written to appliance 204, its LSN “X” is incremented, 506a, and each time that data is replicated to appliance 216, its LSN “Y” is incremented, 506b. This process of data writes and replications continues, along with the corresponding incrementation of the LSN associated with each appliance.

At 508, appliance 204 begins a shutdown process, 508. As part of the soft shutdown, LSN X is written to external witness 232, 510. At the same time, appliance 216 begins a shutdown process, 512. As part of the soft shutdown, LSN Y is written to external witness 232, 518. External witness 232 will only record the highest LSN value (LSN W) that is attempted to be written thereto by appliance 204 and appliance 216, 520. Since, in an example, appliance 204 and appliance 216 shut down at the same time, LSN X and LSN Y will be the same value. When appliance 204 is restarted, 520, its LSN X is compared to LSN W to determine whether appliance 204 is current or if it is stale. If LSN X is equal to LSN W, 522, appliance 204 is promoted to primary, 524, and LSN X and LSN W are cleared from external witness 232.

In the event that appliance 216 shut down later than the shutdown of appliance 204 and appliance 216 was promoted to primary, similar to the situation described with reference to FIG. 4, and at least one write to appliance 216 was executed, LSN Y would not be the same as LSN X, such that LSN W equals LSN Y, 520. Accordingly, after appliance 204 is restarted, 520, LSN X will not equal LSN W, 522, and appliance 204 will not be promoted to primary, 526. The system 200 will then wait for appliance 216 to become available, 528, at which time it will be promoted to primary instance, 532, since it has the most recent writes between the two appliances. Data stored on appliance 216 is then replicated to appliance 204, which is now run as the secondary instance, 536.

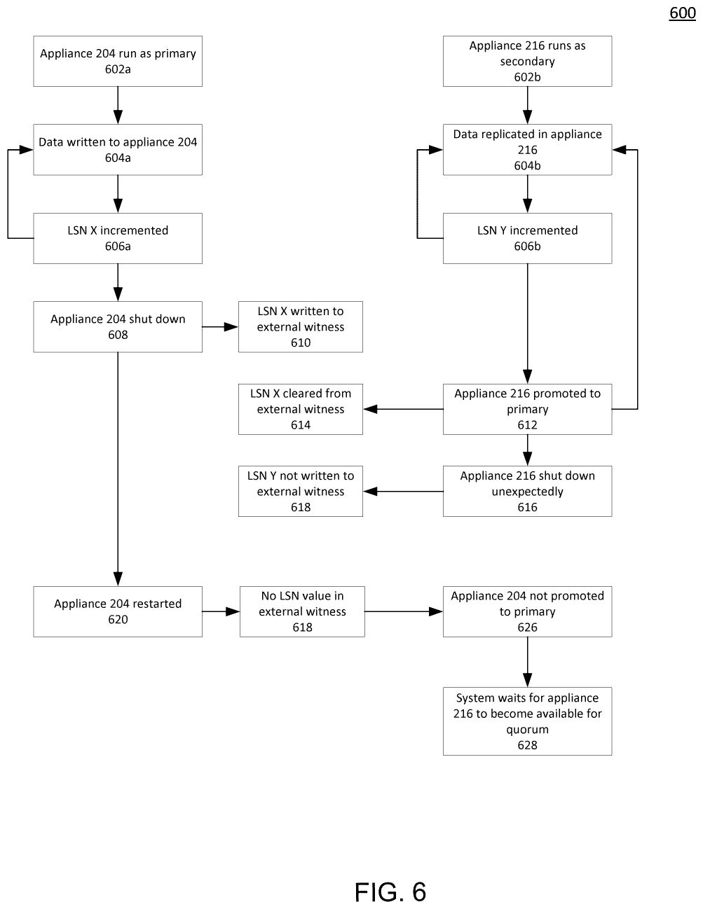

FIG. 6 is an example flow diagram 600 depicting operation of the system 200 to maintain database integrity when appliance 204 is shut down. During regular operation, appliance 204 is designated s the primary instance, 602a, and appliance 216 is designated as the secondary instance, 602b. Data is written to appliance 204, 604a, and replicated to appliance 216, 604b. Each time data is written to appliance 204, its LSN “X” is incremented, 606a, and each time that data is replicated to appliance 216, its LSN “Y” is incremented, 406b. This process of data writes and replications continues, along with the corresponding incrementation of the LSN associated with each appliance.

At 608, appliance 204 begins a shutdown process. During the soft shutdown process, the LSN X stored in appliance 204 is written to external witness 232, 610. In this manner, external witness is able to keep track of the last write executed on appliance 204 before it was shut down. After appliance 204 is shut down, 608, and its LSN X has been written to external witness 232, 610, appliance 216 is promoted to primary instance, since it is still up and running, 612. Upon being promoted, appliance 216 instructs external witness 232 to clear LSN X from its cache, 614. At 616, appliance 216 shuts down unexpectedly, i.e., the shutdown is not a soft shutdown. This could be caused by a system crash, power loss or other situation that would cause an immediate shutdown of appliance 216. Since appliance 216 did not experience a soft shutdown, it is not able to write its LSN Y to external witness 232, 618. Accordingly, external witness 232 does not have a cached LSN value. When appliance 204 is restarted, 620, it attempts to compare its LSN X to an LSN value cached in external witness 232. However, because no LSN value is stored in external witness 232, 618, appliance 204 is not promoted to primary instance, 626, since the system is unable to determine if the replica of appliance 204 is stale. The system 200 will wait for appliance 216 to restart to enable external witness 232 to effect a comparison of LSN X to LSN Y to determine which appliance should be selected as the primary instance. In such an instance, the appliance with the greater LSN value will be promoted to the primary instance.

In general, the system and process for maintaining database integrity includes the following elements:
whenever the witness service 232 restarts, it clears the cached LSN value.
whenever a new primary instance of a database is promoted, it also requests the witness service (if connected) to clear the cached LSN value.
when a replicated database instance stops on an appliance, it requests the witness service (if connected) to set the cached LSN to the last replicated transaction value of that replica.
   the witness service 232 updates the cached LSN value, only if it is greater than the current cached value.
whenever trying to promote a new primary (“potential primary”) among one or more replicas, additionally query the cached LSN value from the witness (if connected), and if set, include that as eligible LSN for comparison purposes
if the minimum number of LSN values are available for comparison:
   if the potential primary does not have a smaller LSN, allow the promote to proceed
   otherwise fail the promote with an error that the replica is stale, to be retried when a replica with the latest LSN is back up
otherwise continue to wait for more replicas/LSN values to be available for comparison

Accordingly, implementations of the disclosure provide a system and method for maintaining database integrity in a data storage system. By storing LSN values in an external witness function, the most up-to-date database is enabled to be promoted to a primary instance after a shutdown and stale databases are prevented from being promoted to a primary instance.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A system comprising:
a first storage appliance for receiving data writes and incrementing an associated last sequence number (LSN) X upon each data write thereto;
a second storage appliance for receiving data writes and incrementing an associated LSN Y upon each data write thereto; and
an external device coupled to the first storage appliance and the second storage appliance;
wherein the first storage appliance and the second storage appliance comprise a cluster management database with data writes being replicated on both the first storage appliance and the second storage appliance; and
upon the first storage appliance beginning to shut down, the LSN X is written to the external device.

2. The system of claim 1, wherein one of the first storage appliance and the second storage appliance acts as a primary instance of the cluster management database and the other of the first storage appliance and the second storage appliance acts as a secondary instance of the cluster management database.

3. The system of claim 2 wherein the first storage appliance is the primary instance and, when the first storage appliance shuts down, the second storage appliance is promoted to become the primary instance and the LSN X stored in the external device is cleared and the second storage appliance continues to receive data writes and increment LSN Y.

4. The system of claim 3 wherein, upon the second storage appliance beginning to shut down, the LSN Y is written to the external device.

5. The system of claim 4 wherein, when the first storage appliance is restarted, it compares its LSN X to the LSN Y stored in the external device.

6. The system of claim 5 wherein, when LSN X equals LSN Y, the first storage appliance is promoted to become the primary instance.

7. The system of claim 5 wherein, when the LSN X is less than the LSN Y, the first storage appliance is not promoted to become the primary instance.

8. The system of claim 3 wherein, when the first storage appliance is restarted, it compares its LSN X to the LSN Y of the second storage appliance.

9. The system of claim 8 wherein, when the LSN X is less than the LSN Y, the second storage appliance remains the primary instance.

10. The system of claim 9 wherein writes to the second storage appliance before the first storage appliance is restarted are written to the first storage appliance.

11. A computer-implemented method, executed on a computing device, comprising:
receiving data writes at a first storage appliance and incrementing an associated last sequence number (LSN) X upon each data write thereto;
receiving data writes at a second storage appliance and incrementing an associated LSN Y upon each data write thereto;
wherein the first storage appliance and the second storage appliance comprise a cluster management database with data writes being replicated on both the first storage appliance and the second storage appliance; and
upon the first storage appliance beginning to shut down, writing the LSN X to an external witness device.

12. The method of claim 11, wherein one of the first storage appliance and the second storage appliance acts as a primary instance of the cluster management database and the other of the first storage appliance and the second storage appliance acts as a secondary instance of the cluster management database.

13. The method of claim 12 wherein the first storage appliance is the primary instance and, when the first storage appliance shuts down, the second storage appliance is promoted to become the primary instance and the LSN X stored in the external witness device is cleared and the second storage appliance continues to receive data writes and increment LSN Y.

14. The method of claim 13 wherein, upon the second storage appliance beginning to shut down, the LSN Y is written to the external device.

15. The method of claim 14 wherein, when the first storage appliance is restarted, it compares its LSN X to the LSN Y stored in the external device.

16. The system of claim 15 wherein, when LSN X equals LSN Y, the first storage appliance is promoted to become the primary instance.

17. The system of claim 15 wherein, when the LSN X is less than the LSN Y, the first storage appliance is not promoted to become the primary instance.

18. The system of claim 13 wherein, when the first storage appliance is restarted, it compares its LSN X to the LSN Y of the second storage appliance.

19. The system of claim 18 wherein, when the LSN X is less than the LSN Y, the second storage appliance remains the primary instance.

20. A computing system comprising:
a memory; and
a processor configured to:
receive data writes at a first storage appliance and increment an associated last sequence number (LSN) X upon each data write thereto;
receive data writes at a second storage appliance and increment an associated LSN Y upon each data write thereto; and
write the LSN X to an external witness device upon the first storage appliance beginning to shut down;
wherein the first storage appliance and the second storage appliance comprise a cluster management database with data writes being replicated on both the first storage appliance and the second storage appliance.
